(19) United States
(12) Patent Application Publication
(10) Pub. No.: US 2012/0247393 A1
(43) Pub. Date: Oct. 4, 2012

(54) PET BED AND EXERCISE APPARATUS

(76) Inventors: RHETT J. SNYDER, Boulder, CO (US); Bryan Edwards, Boulder, CO (US); Leah Maher, Santa Rosa, CA (US)

(21) Appl. No.: 13/078,964

(22) Filed: Apr. 2, 2011

(51) Int. Cl. A01K 29/00

(52) U.S. Cl. 119/28.5

(57) ABSTRACT

A pet bed combination apparatus is constructed of three cushions, with two edges of each cushion attached to a different one of the other cushions. The pet bed combination has a front and rear opening and forms a tunnel structure that a burrowing pet can enter to and exit from either of the two openings. The pet bed combination is triangular in shape when viewed from the front or rear opening. The pet bed combination can be used by a pet for exercise or as a place to rest, and the dimensions of the pet bed combination are selected so that when the primary pet using the apparatus tunnels into the bed, the three inside surfaces of the apparatus are in contact with the pet.

### BACKGROUND

1. Field of the Invention

The present disclosure relates generally to pet furniture and specifically to canine furniture and exercise apparatus.

2. Description of Related Art

Furniture designed to be used by a pet, such as a canine, to sleep on can be constructed of a single cushion or some variant of a cushion that the pet can lay on while resting or sleeping. The cushion can be constructed of a durable and flexible outer covering material, and the outer covering can be stuffed with a soft inner material that easily compresses and then returns to its original shape after many, repeated compressions. This inner stuffing material can be a foam material, natural material or man-made material that is soft and which easily compresses. Or, the stuffing can be comprised of a granular material that easily conforms under weight to the pets body shape. Pet furniture of the single cushion design can be of almost any geometric shape (rectangular, circular, square, etc.) and they can be designed to be substantially flat over their top surface as illustrated in FIG. 1C, or they can be designed with a raised portion that is proximate to the edges or circumference of the top surface of the furniture as illustrated in FIGS. 1A and 1B.

Pet furniture can also be constructed to be in the form or a tent. In the case of the tent shaped furniture, there is only a single opening at a front end of the furniture and the furniture can have a flat floor and an upper portion that is semi-circular in design. A tent pet furniture design is illustrated in FIG. 2. Typically, the tent pet furniture design is used by a canine for resting in the interior of the tent.

Pet apparatus can also be designed for exercise. One such apparatus designed to provide a place for pets to exercise can take the form of a tunnel. Such a pet exercise apparatus typically includes two openings, one opening at each of the two opposing ends of the tunnel. The tunnel design is typically circular in cross section, and can be made of any suitable material that is both durable and flexible. The walls of the tunnel can be filled with a soft, compressible material, but this is typically not a requirement. An example of a pet exercise apparatus in the form of a tunnel is illustrated in FIG. 3. Alternatively, a combination pet bet and exercise apparatus such as that illustrated in FIG. 4 can be designed to have a flat bottom section that rests upon a floor or some other flat surface and a semi-circular upper section. Together the bottom and top section form a tunnel structure with an opening at either end of the tunnel. The bottom portion of this combination pet furniture design can be constructed so that it provides the pet with a soft, comfortable surface upon which the pet can rest and the upper section can be constructed of material that is rigid enough to hold the semi-circular shape without collapsing onto the bottom portion.

While the pet furniture design in the form of a single cushion is reasonably simple to manufacture, it does not provide a pet with a cozy/contained, safe place to rest. Such a design does not provide the pet with a den-like experience which can be very comforting to certain breeds of canines. The pet furniture in the form of a tent can provide the animal with a warm and safe place to rest, but is more difficult to manufacture (therefore typically more expensive) and cannot be used by the pet for exercise, as the tent only includes a single entrance/exit. The pet tunnel design is appropriate for providing the pet with an apparatus that it can use for exercise, but it does not necessarily provide the pet with a comfortable place to rest as does the tent shaped or cushion like furniture. The combination pet tunnel/furniture design as illustrated in FIG. 4 can provide the pet with both a comfortable, covered place to rest in as well as an apparatus that can be used for exercise. However, the combination pet tunnel furniture design in FIG. 4 limits the pet to resting in the furniture covered by the tunnel.

### SUMMARY

For all of the above reasons, it is desirable that an item of pet furniture combines a design that is both conducive to exercise and in which provides a pet with a warm, safe place to rest. In one embodiment a pet furniture combination is comprised of three rectangular shaped, compressible cushions, each one of which includes four edges and a top and bottom side, and each of two opposing edges of each one of the cushions are attached to one edge of one of the other cushion to form the pet furniture combination with first and second open ends and three sides. Further, the pet furniture combination is designed according to the size of the pet so that the interior sides of the cushions all come in contact with the pet's body.

### BRIEF DESCRIPTION OF THE DRAWINGS

FIG. 1A-1C are illustrations of an open cushion type pet furniture design.

FIG. 2 is an illustration of an enclosed/tent pet furniture design.

FIG. 3 is an illustration of a pet tunnel suitable for pet exercise.

FIG. 4 is an illustration of a combination pet furniture/tunnel design.

FIG. 5 is one embodiment of a pet furniture combination.

FIG. 6 is an illustration of a single cushion used to form one embodiment.

FIG. 7 is an illustration of three cushion sections formed from the single cushion in FIG. 6.

FIG. 8 is an illustration showing component part of an alternative embodiment.

FIG. 9A is an illustration of a pet resting inside the pet furniture combination.

FIG. 9B is an illustration of a pet resting on top of the pet furniture combination.

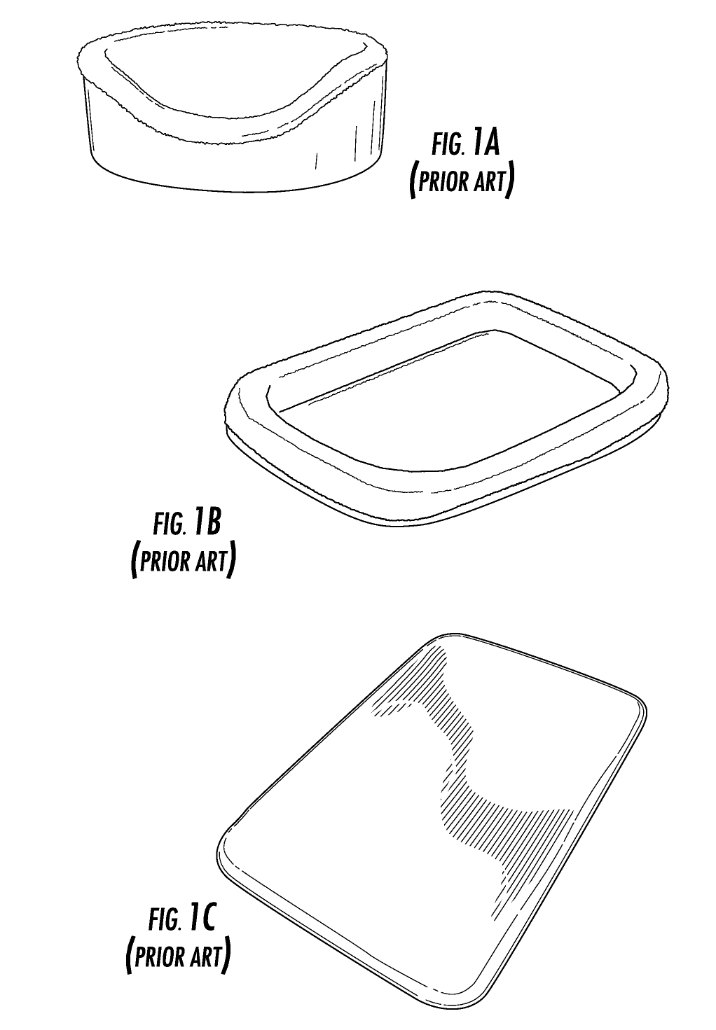

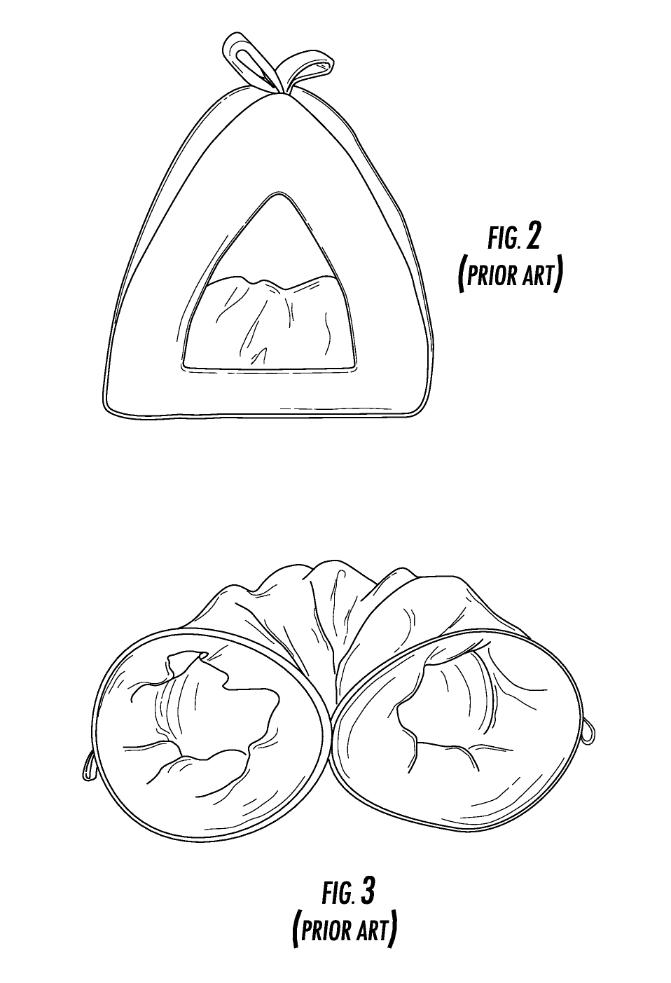

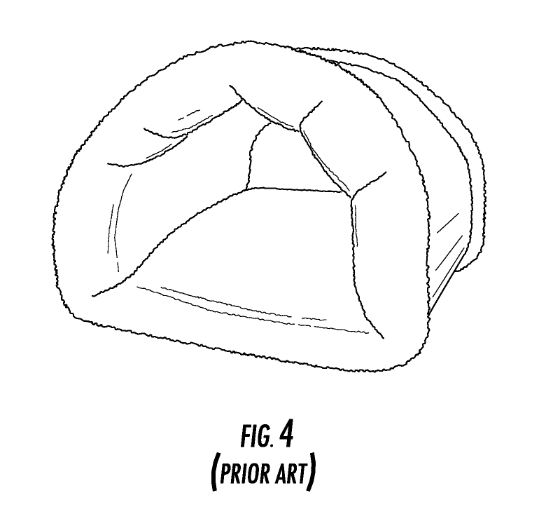

### DETAILED DESCRIPTION

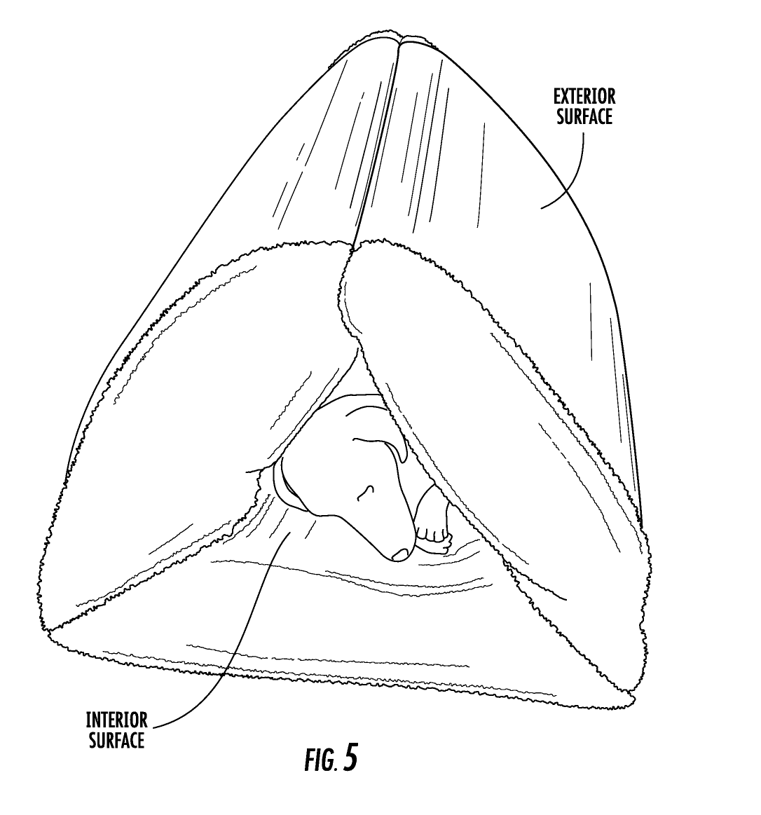

FIG. 5 is an illustration of an embodiment of a combination pet furniture and pet exercise apparatus which will be referred to hereinafter as a pet furniture combination. The pet furniture combination can be comprised of three separate cushioned sections, section 1, 2 and 3, that when connected together form the pet furniture combination. Alternatively, the three cushioned sections can be formed from a single cushion (illustrated in FIG. 6) that is comprised of an outer covering and inner stuffing made of a compressible or granular material. The fully assembled pet furniture combination as illustrated in FIG. 5 can have an exterior surface area comprising one side of each of the three cushions as labeled, and the pet furniture combination can have an interior surface area comprising the opposite side of each of the three cushions. The outer covering of the cushions can be composed of any flexible material, either man-made or natural, and be of a thickness that provides enough durability so that it is not easily punctured or torn by pets. The interior area of the covering material can have a fleecy texture or it can have a smooth texture. So for instance, the exterior surfaces of each of the cushions can be made of a material with a smooth texture and the interior surfaces of each of the cushions can be made of a fleecy or thick, pile material to provide more comfort for the pet. The inner, compressible/granular material (stuffing) described above can be any soft, compressible material such as foam or fiber-like stuffing that is easily compressed by the weight of a pets body and which returns to its original, uncompressed shape when the pet leaves, or the stuffing material can be composed of a granular material of a uniform size such as beads that readily conforms to the pets body.

In important feature of the pet furniture combination design is that of coziness. In this context, coziness means that the interior surfaces of all three cushions can come in contact with the pet when the pet is positioned in the interior of the pet furniture combination. It was found that bodily contact with each of the three interior surfaces of the three cushions provides a sense of security for the pet that it would not otherwise experience.

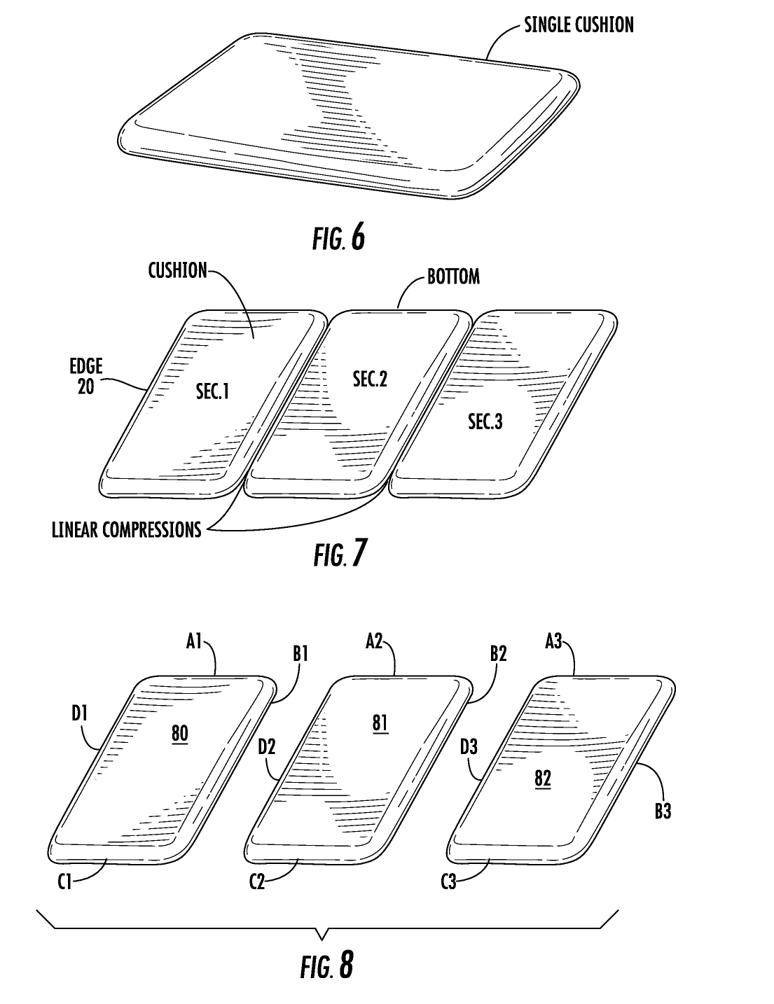

As described above, the pet furniture combination is comprised of three cushioned sections. These cushioned sections can be formed from the single cushion shown in FIG. 6 by linearly compressing and connecting opposing sides of the outer covering of the single cushion, such that the opposing sides of the single cushion are proximate to each other along the length of the linear compression. FIG. 7 is an illustration of the three cushioned sections formed from the single cushion. As the result of this linear compression, there will be some inner material compressed between the two opposed sides of the cushion outer covering along the length of the linear compression, and this material is compressed as much as practical (depending upon the process used for connection) so that the opposing sides almost touch along the linear compression or seam. The opposing sides of the outer cushion covering can be connected to each other along the length of the linear compression with any thread-like material that is strong enough for the purpose or by any other means that results in maintaining the necessary linear compression of the single, rectangular shaped cushion element in order to form the three cushioned sections.

In another embodiment, instead of forming the pet furniture combination from a single cushion divided into three cushioned sections, three single cushions can be connected together to form the pet furniture as shown in FIG. 8. This embodiment has the advantage that the inner, stuffing material can be easily removed from one end of the cushion (through zippered opening for instance) to accommodate washing the furniture combination. In this embodiment the inner stuffing material can be contained by a cover. The cover can envelop the stuffing material and can be composed of any light weight material that is strong enough so that it does not tear under the weight of the pet. Containing the stuffing material in this manner allows it to be more easily removed from the furniture outer covered so that the outer covering material can be cleaned.

FIG. 8 shows three single cushions that are not connected one to another. Preferably, each of the three cushions are of substantially the same dimensions and are square or rectangular in shape, but these characteristics are not critical to the design of the pet furniture combination. Each of the single cushions have four edges. Cushion 81 is comprised of edges A1, B1, C1 and D1, cushion 82 is comprised of edges A2, B2, C2 and D2 and cushion 82 is comprised of edges A3, B3, C3 and D3. In cross-section, each of the edges can have a rounded profile such as the edge profile, or each edge can have a rounded profile that comes to a point. In this embodiment, two opposing edges of each one of the three single cushions are connected to another edge of another cushion to form the pet furniture combination. To start the construction process, any edge of one of the three cushions can be connected to an edge of any one of the other cushions. So, for instance, edge B1 of cushion 80 can be connected to edge D2 of cushion 81 and edge B2 of cushion 81 can be connected to edge D3 of cushion 82. Then, in order to complete the pet furniture combination construction, edge B3 or cushion 82 is connected to edge D1 of cushion 80. More specifically, in order to complete the construction of the pet furniture combination, substantially the entire edge B3 of cushion 82 is connected to substantially the entire edge D1 of cushion 80 by the means described earlier.

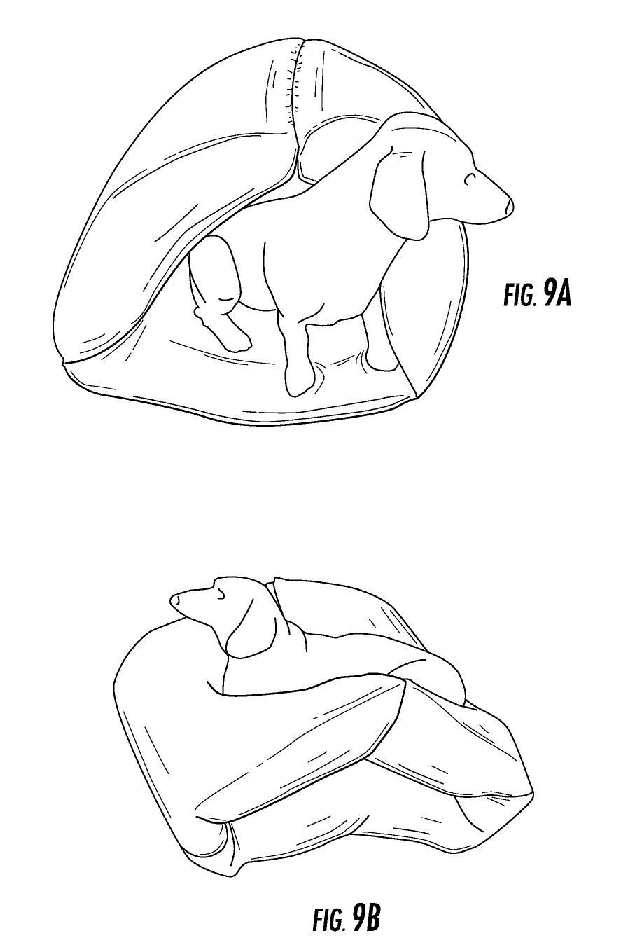

As shown in FIGS. 9A and 9B, a pet, such as a canine, can respectively rest inside or on top of the pet furniture combination. Any of the three cushions 80-82 of the pet furniture combination can rest on a flat surface, and a pet is able to rest in the covered portion of the pet furniture combination. Alternatively, as each of the three sections or cushions of the pet furniture combination have similar compressibility, the pet can easily lay on top of the pet furniture combination without regard to its orientation, i.e., without regard to whether an entire cushion section is resting on a flat surface.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. Combination pet bed and exercise furniture, comprising:
three separate cushions, each cushion including four edges a top and a bottom side, and only one of the three cushions is in contact with a flat surface and suitable for a pet to rest upon; and
each of two opposing edges of each one of the cushions attached to one edge of one of the other cushions to form a tunnel that is triangular in cross section when viewed from opposing first and second open ends of the tunnel, and the pet is able to pass through from the first to the second open ends of the tunnel.

2. The combination pet furniture of claim 1, wherein the size of each of the three cushions is determined by the size of a pet.

3. The combination pet furniture of claim 2, wherein each of the three cushions are sized to allow the pet to pass through the furniture and to permit the interior surfaces of each of the three cushions to come in contact with the body of the pet.

4. The combination pet furniture of claim 1, wherein the top side of each of the three cushions forms the exterior surface of the pet furniture combination and the bottom side of each of the three cushions forms the interior surface of the pet furniture combination.

5. The combination pet furniture of claim 4, wherein the exterior surface area is comprised of a smooth textured material and the interior surface area is comprised of a fleece textured material.

6. The combination pet furniture of claim 4, wherein both the exterior and interior surface areas are comprised of a smooth textured material.

7. The combination pet furniture of claim 4, wherein both the exterior and the interior surface areas are comprised of a fleece textured material.

8. The combination pet furniture of claim 1, wherein each of the three cushions are filed with a stuffing material.

9. The combination pet furniture of claim 8, wherein the stuffing material is comprised of a compressible material or a granular material.

10. The combination pet furniture of claim 8, wherein the stuffing material is completely enveloped in a flexible material.

11. The combination pet furniture of claim 10, wherein the enveloped stuffing material is removable from each of the three cushions.

12. Combination pet bed and exercise furniture, comprising:
a first, second and third cushion section formed from a single cushion, each of the three cushion sections including four edges and a top and a bottom side, and only one of the three cushions is in contact with a flat surface and suitable for a pet to rest upon; and
a first edge of the first cushion section attached to an edge of the second cushion section, an opposite edge of the second cushion section attached to a first edge of the third cushion section, and an edge opposite the first edge of the first cushion section attached to an edge opposite the first edge of the third cushion section to form a tunnel that is triangular in cross section when viewed from opposing first and second open ends of the tunnel, wherein the pet is able to pass through the tunnel from the first to the second open end.

13. The combination pet furniture of claim 12, wherein the size of each of the three cushion sections is determined by the size of a pet.

14. The combination pet furniture of claim 12, wherein each of the three cushion sections are sized to allow the pet to pass through the furniture and to permit the interior surfaces of each of the three cushions to come in contact with the body of the pet.

15. The combination pet furniture of claim 12, wherein the top side of each of the three cushion sections forms the exterior surface of the pet furniture combination and the bottom side of each of the three cushions forms the interior surface of the pet furniture combination.

16. The combination pet furniture of claim 15, wherein the exterior surface area is comprised of a smooth textured material and the interior surface area is comprised of a fleece textured material.

17. The combination pet furniture of claim 12, wherein each of the three cushion sections are filed with a stuffing material.

18. The combination pet furniture of claim 17, wherein the stuffing material is comprised of a compressible material or a granular material.

19. The combination pet furniture of claim 17, wherein the stuffing material is completely enveloped in a flexible material.

20. The combination pet furniture of claim 19, wherein the enveloped stuffing material is removable from each of the three cushions.
